(19) United States
(12) Patent Application Publication
(10) Pub. No.: US 2013/0079903 A1
(43) Pub. Date: Mar. 28, 2013

(54) BUILDING AUTOMATION SYSTEM

(71) Applicants: Harald Kemmann, Velbert (DE); Roland Seifert, Hamm (DE)

(72) Inventors: Harald Kemmann, Velbert (DE); Roland Seifert, Hamm (DE)

(21) Appl. No.: 13/261,480

(22) PCT Filed: Apr. 20, 2011
(86) PCT No.: PCT/DE11/00432

§ 371 Date: Dec. 4, 2012

(30) Foreign Application Priority Data
Apr. 20, 2010 (DE) 10 2010 015 509.8

(51) Int. Cl. G06F 17/00

(52) U.S. Cl. 700/83

(57) ABSTRACT

The invention relates to a system for building automation, made up of a portable or handheld apparatus for situation-related information configuration and of at least one stationary unit, in which system the apparatus comprises a proximity sensor, a communication unit for wireless communication with at least one of the stationary units, an evaluation and control unit having at least one processor or logic unit and a memory, an information output unit, and an energy reservoir, the system being designed to create a wireless communication connection between the apparatus and at least one of the stationary units via the communication unit as a consequence of an approach by the apparatus, as ascertained by the proximity sensor, to at least one stationary unit, and to display a state of the at least one stationary unit via the information output unit.

The invention relates to a system for building automation, and in particular to a system made up of a portable or handheld apparatus for situation-related information configuration, and at least one stationary unit for building automation.

A plurality of systems that permit centralized or decentralized control of building technology are known from the existing art. With the aid of such systems it is possible, for example, for the occupants of a building to regulate the room temperature of building in decentralized fashion or via a central control system, for example by the fact that remotely controllable thermostatic valves are individually readjusted for each room, or control is applied directly to a central heating system. Similar systems are known for lighting control, for applying control to roller-shade motors, or very generally for controlling the supply of electricity within a building in order to start up or shut down individual consumption points. The use of centralized media serves and security systems is likewise known from the existing art.

Standards relevant to building automation encompass DIN EN ISO 16484 relating to building automation systems, VDI 3813 relating to the presentation of room automation efficiency, DIN V 18599 relating to energy evaluation of (non-residential) buildings, and DIN EN 15232 relating to the influence of building automation on energy efficiency.

A centralized or decentralized control unit, which besides applying control to individual building system components can also display its actual state, is often provided for this. Communication between the control unit and the individual building system components can be embodied in wire-conducted or wireless fashion.

Independently of the aforesaid centralized or decentralized building control system, but also in combination with such a system, it is moreover known to apply control to individual building system components, wirelessly or in wire-conducted fashion, via a remote controller, which likewise already has convenience advantages since with the aid of such a remote controller an occupant of the building, for example, no longer needs to actuate a plurality of switches located at different places, but instead can, for example, switch the lights on and the ventilation off via the remote controller in decentralized fashion, and thus approximately independently of location.

US 2009/0057425 A1 discloses a system for remote control of individual building system components. Linkage of a remote controller, for example a computer, to a centralized building control system occurs with the aid of an IP- or Internet-based communication linkage between the remote controller and the building control unit, the latter in turn being communicatively connected, in wire-conducted or wireless fashion, to a variety of building system components to which control can be applied.

It has emerged that the centralized or decentralized application of control to technically and functionally differing building system components often results in considerable demands being placed not only on the technical comprehension of a user but also on the technical infrastructure present in the building being automated. For example, a large number of building control systems known from the existing art are not capable of being retrofitted, with manageable outlay, at a later time, i.e. after completion of the building, since, for example, electrical and/or data-transfer lines that connect the building system components to one another and/or to the centralized or decentralized building control unit are required, but are not present as standard equipment.

Initial attempts to reduce the technical complexity of the aforesaid systems are based on the fact that formerly wire-conducted data-transfer lines have been replaced by technologies for wireless data transfer. In order to simplify the operability of known systems, it is known, for example, to use graphical human machine interfaces (hereinafter “HMI”), preferably also in conjunction with a touch-sensitive display with which a user can as intuitively as possible, by “pointing a finger,” configure or apply control to a very wide variety of building system components. One such HMI is, for example, known from KR 10 2007 011 9945 A. The use of tactile inputs and outputs is also known.

It is moreover known from KR 10 2009 000 9228 A to limit the functional scope of a mobile unit for building automation to a restricted number of system components arranged in the immediate vicinity of the mobile unit, for which purpose the mobile unit is designed to detect controllable system components in its surroundings and to direct its functional scope correspondingly to them. US 2007/0294645 A1 discloses a similar apparatus and a method for detecting an approach of a mobile unit, and for establishing a data transfer connection as a consequence of an approach of a mobile unit.

DE 20 2009 006 060 U1 discloses an electrical positioning drive for heating element valves, which drive can likewise be embodied in radio-controllable fashion as a possible building system component.

US 2008/0313566 A1 discloses a building control system that comprises a stationary and a portable unit, the stationary unit being designed to correspondingly update and initialize the portable unit, as a function of the functional scope of the portable unit selected by a user of the portable unit, so that the latter has the desired functional scope. For example, if a user of the portable unit intends to use it to readjust remotely controllable heating element valves that are connected to the stationary unit, the stationary unit then initializes the portable unit accordingly. It is thus possible to develop, for example, instead of a portable remote controller in which a plurality of input elements (such as buttons) are provided for outputting permanently assigned control instructions, a remote controller that possesses only a limited number of input elements to which corresponding control instructions are dynamically assigned depending on the functional scope desired by a user at a given point in time.

Although the systems described above that are known from the existing art already contain initial outlines of building-automation solutions for implementing more user-friendly building control systems, the object of the present invention is intended to be that of proposing a system made up of a portable or handheld apparatus for situation-related information configuration, and at least one stationary unit for building automation, which system substantially simplifies a user's interaction with individual, or groups of, building system components. The possibilities, made available by the system to be proposed, for user interaction with the building system components are in principle not intended to be limited only to the application of control thereto. The system is instead also intended to be designed to encompass a state display by way of which at least one state of a building system component is displayable.

This object is achieved according to the present invention by a system in accordance with claim 1. A preferred method for wireless location-linked operation, control, and configuration of electronic building-automation devices and components, using a system according to the present invention, is the subject matter of the coordinated claim 21. Preferred embodiments may be gathered from the respective dependent claims.

According to the present invention, the system is made up of a portable or handheld apparatus for situation-related information configuration and of at least one stationary unit for building automation, the portable or handheld apparatus comprising a proximity sensor, a communication unit for wireless communication with at least one of the stationary units, an evaluation and control unit having at least one processor and a memory, an information output unit, and an energy reservoir. The system is designed to create a wireless communication connection between the apparatus and at least one of the stationary units via the communication unit as a consequence of an approach by the apparatus, as ascertained by the proximity sensor, to at least one stationary unit, and to display a state of the at least one stationary unit via the information output unit.

When the statement that the system in question is provided “for situation-related information configuration” appears in the present Application, this is intended to acknowledge the circumstance that the proposed system is manifested, in its functional features that are essential for building automation, in a situation-dependent and/or state-dependent manner. This adaptability of the system can, for example, encompass the capability of embodying selected building system components, as stationary units, to be controllable via the portable apparatus; but on the other hand, if the system or one of its components is provided, at a user's request or independently thereof, (only) for the output of an information item, for example the temperature inside a room or the current power consumption of a consumption point, of relating to the output of such information. The adaptability can also be confined to individual functional features of the system.

Depending on the embodiment, provision can be made that, for example, the functional scope and/or presentation scope of the portable apparatus adapts itself as a function of its whereabouts. For example, if the portable apparatus is located inside a room in a building in which a lighting system and a remotely controllable heating element valve are located as relevant building system components, provision can then be made according to the present invention that the portable apparatus has assigned to it a functional scope that encompasses at least the operability of those components, or also (exclusively) enables information output regarding a state of (one of) those components.

Provision is made according to the present invention that the communication unit creates a wireless communication connection between the apparatus and at least one of the stationary units as soon as a proximity sensor in the portable apparatus ascertains the latter's approach to said at least one stationary unit. Particularly preferably, the situation-related information configuration is therefore also initialized as a consequence of the approach ascertained by the proximity sensor.

By way of example, but preferably, the situation-related information configuration is to take place selectably as a consequence of satisfaction of one or more of the following conditions:
1. Near-field linking: The portable apparatus is located in the physical vicinity (e.g. 0 to 2 m) of at least one stationary unit. It is also conceivable, if multiple portable apparatuses happen to be located in a definable physical vicinity, for the manifestation of the situation-related information configuration to depend selectably on that circumstance.
2. Type of stationary unit: The type of at least one stationary unit defines the operating capabilities and functional scope of the portable apparatus. Examples of types of stationary units are switches, electrical outlets, sensors, actuators, and thermostats. It is particularly preferred that the portable unit exhibit the same functional scope as at least one stationary unit associated in situation-dependent fashion.
3. Location of portable apparatus: At least portions of the situation-related information configuration can depend on the location of the portable apparatus in the room, and/or on the orientation with reference to at least one stationary unit. In addition to the location and orientation of the portable apparatus, its whereabouts can also be employed for constituting the situation-related information configuration. It may be useful for this purpose for the portable apparatus to possess a position determination system. This can be based, for example, on radio triangulation, for example on WLAN triangulation.
4. State: At least portions of the situation-related information configuration can depend on at least one state of at least one system component, i.e. of at least one stationary unit and/or at least of the portable apparatus.
5. Motion state of the portable apparatus: At least portions of the situation-related information configuration can depend on a motion state of the portable apparatus. Both accelerations of the portable apparatus, and translational or rotational motions thereof with reference to at least one stationary unit or to a definable coordinate system, can be incorporated.
6. User-dependent: At least portions of the situation-related information configuration can be manifested as a function of the person who is interacting with the portable apparatus. It is thereby possible to implement, for example, personalization of the functional scope of the portable apparatus.
7. Time of day: At least portions of the situation-related information configuration can depend on the time of day. It is thus possible, for example, for the functional scope of the portable apparatus to be manifested, for example expanded or limited, as a function of time of day. A seasonally dependent adaptation of the situation-related information configuration is likewise possible, so that, for example, an interaction between the portable apparatus and a central heating system is provided exclusively in the winter months.
8. Compass direction: Lastly, it is possible for the situation-related information configuration to depend, at least to a limited extent, on how the portable apparatus is oriented with reference to the four cardinal points.

It is also conceivable, however, for the at least one stationary unit to encompass, or to be able to apply control to, a centralized or decentralized building control bus system, so that as a consequence of the situation-related information configuration as the portable apparatus approaches the stationary unit, it embodies the entire functional scope, or substantial parts, of the building control bus system, and the portable apparatus thus takes on, for example, the function of a remote controller for the home control bus system.

Leaving aside the units provided for controlling a bus system, the stationary units can be divided essentially into two categories. These encompass on the one hand sensors, such as light sensors, thermostats, temperature sensors, or moisture sensors; and on the other hand actuators, such as switchable outlets, switchable lamp sockets, dimming lamp sockets, relays, or media servers. Consideration must also be given to mixed stationary units, such as building security systems (e.g. fire protection or break-in protection system), that can exhibit both actuator and sensor functionalities.

Lastly, the stationary unit can also be provided in order to accommodate the portable apparatus, for example for storage purposes or in order to recharge an energy reservoir of the portable apparatus. If the portable apparatus and the stationary unit are coordinated with one another in such a way that the portable apparatus is intended to exhibit, as a consequence of situation-related information configuration as it approaches the stationary unit, a functional scope identical or approximately identical to that of the stationary unit, provision can then be made that the stationary unit is embodied in such a way that it enables reception of the portable apparatus without itself being impaired in terms of its functional scope. Particularly preferably for this purpose, the stationary unit is embodied in such a way that reception of a portable apparatus causes the exchange of identical functional surfaces of the two system components, such that once reception has occurred, a functional surface of the portable unit replaces a corresponding surface of the stationary unit.

According to the present invention, the portable apparatus and the at least one stationary unit communicate wirelessly with one another. Advantageously and preferably, the protocol used for this is one that requires little power consumption and can be implemented using inexpensive hardware. The current state of the art would be, for example, the use of the IEEE 802.15.4 standard.

If the stationary unit is provided, as in one of the examples above, for creating a linkage between the portable apparatus and a building control bus system, the linkage between the bus system and the stationary unit is then preferably embodied with the aid of the KNX standard (which is particularly relevant for building automation), via a local operating network (LON), or with the use of the BACnet standard that is likewise known from building automation. Alternatively, local networks can also be used, such as the Ethernet very largely standardized in the IEEE 802.3 standard, or a W-LAN network of the IEEE 802.11 family. Further standards known from building automation are the European Installation Bus (EIB) per EN50090, and the LCN, WAGO I/O, DALI, CAN, M-bus, Modbus, Profibus, digitalSTROM, 1-wire, and DMX standards. Among the powerline standards are the X10, Insteon, HomePlug, and HomePNA standards. Known radio standards are the Enocean, Z-Wave, ZigBee, Moeller XComfort, and Bluetooth standards. Software standards particularly relevant to building control encompass the UPnP, OPC, OSGi, and dlna standard.

Be it noted that the stationary units need not obligatorily be networked with one another, although this can be useful depending on the application.

The proximity sensor can be implemented very generally, involving evaluation of an electromagnetic, optical, or acoustic signal. Signal evaluation can also occur entirely capacitively or entirely inductively, i.e. the evaluation can involve exclusively electric or exclusively magnetic fields. By preference, corresponding field strengths or power levels, frequency changes, or time delays can be evaluated.

In a preferred embodiment, the proximity sensor is designed to measure the radio field of the communication unit. It is particularly preferred in this context to use the localization or “ranging” functionality of the communication unit, as implemented e.g. with the aid of the IEEE 802.15.4 wireless personal area networks (WPAN) standard. This is known to one skilled in the art from Annex D1 (Location topics) of IEEE standard 802.15.4a of the year 2007. The aforementioned standard is based on a time offset measurement.

In a simpler embodiment involving evaluation of the radio field of the communication unit, the measurement of the distance and/or position of the portable apparatus occurs with reference to the stationary unit, with evaluation of the radio field strength of the communication unit via the proximity sensor. It is furthermore conceivable to use methods known from the existing art, based on frequency change measurements, to determine an approach or departure of the portable apparatus relative to the stationary unit.

It is likewise possible, using ISO/IEC standard 19762-5 (real-time locating system, RTLS), to implement a system according to the present invention in which, in order to determine the position of the portable apparatus, the proximity sensor determines the relative time delay and thus the relative position of the apparatus with respect to at least three stationary units.

As already discussed, it is a characteristic property of the system according to the present invention that it exhibits at least one functionality that is manifested in situation-dependent fashion. Provision can be made in this context that the functionality of the portable apparatus is based not only on which stationary unit the portable apparatus is currently in communicative connection with for data exchange, but also on the manner in which a user is interacting with the portable apparatus. The user's interaction with the portable apparatus can consist, for example, in the fact that he or she is viewing a specific surface of the portable apparatus, or is turning such a surface toward or away from a stationary unit. Both of these possibilities for a user's interaction with the portable apparatus can be provided, for example, in order to activate or deactivate a functionality associated with the corresponding surface of the portable apparatus, or to transfer a user's control instruction to the portable apparatus or, by way thereof, to the stationary unit.

For implementation of the embodiment recited above, it is necessary for the system according to the present invention, preferably the portable apparatus itself, to be capable of determining the orientation in space possessed by the portable apparatus, preferably by a distinguished surface thereof, or the manner in which the portable apparatus is oriented relative to a specific stationary unit. Because provision is made according to the present invention that the portable apparatus is communicatively connected to at least one stationary unit, it is particularly preferred to determine the orientation of the portable apparatus, or of a distinguished surface thereof, with reference to the at least one stationary unit, so as thereby also to allow an inference as to the absolute orientation of the portable apparatus in space.

Particularly preferably, this is achieved with the aid of antenna diversity, the individual antennas, such as e.g. ceramic antennas, waveguides on a substrate, and the like preferably radiating in a distinguished direction and their principal radiating lobe being oriented either perpendicular to a distinguished surface of the portable apparatus, in the direction of distinguished or notional corners, or perpendicular thereto. An example that may be mentioned here is a system having a substantially cubical portable apparatus in which a directional antenna is arranged at each of the eight cube corners or the twelve cube edges. Particularly preferably, the principal radiating lobes of the directional antennas would then be oriented in such a way that they meet, in their backward prolongation, at the center of symmetry of the cube. The above-described concept for antenna arrangement can be transferred in obvious fashion to portable apparatuses that deviate from cubical geometry. It is thus possible, by evaluating the field strengths of the individual receiving antennas, to determine the location of an identified surface of the portable apparatus with reference to the stationary unit.

In the case of portable apparatuses that comprise surfaces which are substantially only perpendicular to one another, for example cubical or parallelepipedal portable apparatuses, the determination of the location of an identified surface preferably occurs in that that surface of the portable apparatus which is facing toward a stationary unit is determined, so as to infer, in this manner, the surfaces having the respectively associated functionalities. In order to increase the accuracy with which the orientation of the portable apparatus is determined, provision can also be made that besides the field strength evaluation, additional consideration is given to the time delay between the signals arriving at the various antennas, or their phase shift. It is thereby possible, for example, to block out received signals that arrive in delayed fashion as a result of reflection. One skilled in the art will recognize that the above-described principle for determining position based on antenna diversity is also transferable to portable apparatuses deviating from cubical or parallelepipedal geometry. Merely by way of example, be it noted that a spherical portable apparatus can also contain a notional or actual cubical portable apparatus, for example such that the corners of the (notional) cube lie at the surface of the sphere.

According to the present invention, in a simplest embodiment the proposed system is directed solely toward the fact that the portable apparatus makes available an information output about a state of the at least one stationary unit. Provision can be made, for example, that by way of the portable apparatus the power consumption of a stationary unit, or the power consumption ascertained by it with regard to an associated consumption point or an energy source, is displayed as soon as the portable apparatus arrives in the near field of the corresponding stationary unit and a wireless communication connection has been established. In this embodiment the portable apparatus serves only as a situation-related information output.

In a further embodiment of the system the apparatus is designed to transmit to a stationary unit, in remotely communicative fashion, a state signal that contains information about a desired state of that unit. In other words, in this embodiment of the system the portable apparatus additionally possesses the function of remotely controlling the stationary unit.

According to a further configuration of the aforementioned embodiment, the apparatus comprises at least one input unit by way of which a desired state of a stationary unit is definable. Independently thereof, the portable apparatus can possess further input units that are useful, depending on the embodiment of the portable apparatus, for operating it. Because the system according to the present invention is directed toward an intuitive operating concept, provision can also be made that at least one input unit has a situation-dependent function, i.e. either can serve for the above-described definition of a desired state of the stationary unit, or is provided, for example, for definition of a desired operational state of the portable apparatus by a user. It is useful, for this purpose, that a situation-related operating scope is assigned to the respective input unit. The embodiment of the input unit is not intended to be restricted to a specific technical implementation. In addition to keys and buttons of any kind (electromechanical, sensory, capacitive, and the like), input units that are embodied on the basis of voice recognition are also conceivable. The input unit preferably comprises at least one motion sensor or acceleration sensor that is connected to the evaluation and control unit for data exchange, and that permits a definition, based on motions and accelerations of the apparatus, of a desired state of the stationary unit. As already mentioned, the aforesaid sensors can also serve for interaction of a user with the portable apparatus.

The motion sensors and/or acceleration sensors just recited are also suitable in particular for interaction by the user with the portable apparatus, or for controlling the stationary unit, via gestures. It is moreover also conceivable for gestural control of the stationary unit to occur additionally with incorporation of the positionally dependent components of a gesture. In this case the portable apparatus comprises means for determining its position. Gestural control of the stationary unit, however, is essentially intended to occur upon evaluation of an acceleration sensor that the stationary unit comprises. In a particularly preferred embodiment, the implementation of gestural control is accomplished with the aid of the proximity sensor. As already explained, it is possible to embody the proximity sensor in such a way that it is used to determine the relative arrangement of the portable apparatus with reference to the stationary unit. Relative motion of the portable apparatus with reference to the stationary unit is thus also possible by repeated evaluation of the proximity sensor signal, and a gesture-based interaction by a user with the portable apparatus, or gesture-based control of the stationary unit, is thereby achievable.

According to a further embodiment of the invention, the portable apparatus comprises at least one position sensor and/or one biometric sensor, which serve for predetermination of an operational state of the apparatus. The aforesaid means are to be designed to predefine the definition of the operational state of the portable apparatus via gestures, via the location of the apparatus relative to a stationary unit, or in a user-dependent, i.e. person-specific manner. Depending on the embodiment of the invention, it may be useful for the portable apparatus to comprise a compass for the detection of position and/or orientation.

In a preferred embodiment, the apparatus is designed to detect and/or define a hierarchy existing between two or more stationary units. For example, provision can be made that when multiple stationary units are within range of the portable apparatus, the latter enters into a connection with a preferred stationary unit. With regard to the selection rules for predetermining the hierarchy between the stationary units, no provision is made for limiting them to specific ones. For example, provision can be made that the portable apparatus always enters into a connection with the physically closest one. Alternatively, provision can also be made that the stationary units possess a predefined ranking order, such that the portable apparatus always enters into a connection with the highest-ranking stationary unit. Lastly, provision can also be made that the portable apparatus itself allows the user to have the capability, for the case in which multiple stationary units are located in the near field of the portable apparatus, of predetermining a hierarchy between the multiple stationary units.

In a refinement of the embodiment recited above, the apparatus comprises at least one functionality whose manifestation depends on an existing hierarchy between the units. It is thus possible, for example, for the portable apparatus to enter into a connection with a specific stationary unit in accordance with the existing hierarchy, but not to leave the stationary units lower down in the hierarchy entirely out of consideration to the extent that the functionality of the stationary unit is (also) constituted in consideration of the existing hierarchy. For explanation, let it be assumed by way of example that when multiple stationary units that possess an at least partly overlapping function (multiple light switches inside a room) are within range of the portable apparatus, the portable apparatus preferentially enters into a connection with a specific stationary unit in accordance with the hierarchy, but also does not leave the other stationary units out of consideration to the extent that they may possess additional functions (for example, multiple switches inside a room, with one switch additionally having a dimming function). It is thus possible for the portable apparatus to connect hierarchically to a corresponding stationary unit, but nevertheless additionally to effect communication with other stationary units with regard to their additional functions (dimming function).

In another embodiment of the invention, the portable apparatus comprises at least one functionality whose manifestation depends on the physical distance of the apparatus from at least one stationary unit. It is thus conceivable, for example, for additional functionalities with reference to a stationary unit to be gradually activated in a portable apparatus as the distance of the portable apparatus from the stationary unit decreases. In exactly the same fashion, it is conceivable for the above-described hierarchy between the stationary units to depend on the spatial direction in which the portable apparatus is moved, preferably as a function of the location of at least one stationary unit. For gestural control in particular, it may be useful if, when multiple stationary units are present in the near field of the portable apparatus, it is possible to apply control to a specific stationary unit regardless of any hierarchy that may exist between the stationary units.

According to a further embodiment, provision can be made that the portable apparatus comprises at least one functionality whose manifestation depends on the spatial orientation or spatial location of the apparatus with reference to at least one stationary unit. It is thus conceivable, for example, for a specific functionality of the portable apparatus to be activated as soon as a specific surface of the portable apparatus is oriented in a specific manner with regard to a stationary unit. For example, if the portable apparatus is substantially cubical, it is thus possible for an input unit that is arranged on the side of the cube facing away from the stationary unit (i.e. on the side facing toward a user) to have a specific functionality assigned to it. It is likewise conceivable for the apparatus to comprise a functionality that depends on the orientation of the apparatus with reference to a definable coordinate system. It is thereby possible to assign to the portable apparatus a functionality whose manifestation depends on the orientation of the apparatus in space. To mention an example: a cubical apparatus is embodied so that a fixed functional scope is defined for each of its six surfaces, but that activation of the corresponding functionality depends on which surface of the portable apparatus possesses a specific orientation in space or with reference to the stationary unit, for example whether the surface is or is not oriented in a user's viewing direction. Provision can thus be made that the apparatus comprises at least one surface that has allocated to it a functionality which is activated as a function of a spatial orientation or spatial location of the surface. In the simplest case this relates, for example, to activation of a display for information output, or to activation of an input unit.

Because it may also happen, in practical application of the system according to the present invention, that multiple portable apparatuses wish to enter into a connection with one or more stationary units, in an embodiment provision is made that the apparatus of the system according to the present invention is designed to define or to detect a hierarchy between itself and further apparatuses for situation-related information configuration. For example, if multiple portable apparatuses are present inside a room and then attempt to enter into connection with the stationary unit or units inside the room, it may be useful for at least one portable apparatus to have the capability of defining a hierarchy between itself and the other portable apparatuses, or of detecting an existing hierarchy. This embodiment is already useful if only for avoiding or limiting conflicts of interest in the context of establishing connections to the stationary units or applying control to them.

According to a preferred embodiment, provision is furthermore made that the portable apparatus is designed for grouping of stationary units, and for saving a grouping in memory. The grouping of stationary units is a central function of building automation. It serves to assign different units, for example lights and switches, to one scenario. This allows users to control, with a single action, all the units assigned to a group. Whereas according to the existing art the grouping occurs via a centralized HMI that on occasion requires a user to have expanded computer knowledge, provision is made according to the present invention that the grouping of the stationary units occurs via natural pointing operations. An example of this “linking” will be explained later.

The grouping of stationary units, or the assignment of a stationary unit to an existing group, can be accomplished by the system according to the present invention automatically or also manually by the user. Because the underlying object of the system according to the present invention is to propose a building control system that can be operated as intuitively as possible, provision is made for the grouping function as well that it is configured to be intuitive and easily manipulated by a technically unskilled user. In order to identify units collected together into a group, it is preferably sensible to use colors, patterns, and symbols as group identifiers for a small number of groups, and letters, names, and numbers for a large number of groups. It is likewise conceivable to use combinations of these group identifiers, for example letters and numbers.

Selection of a group preferably occurs by way of a characteristic motion, to be executed by the user, of the portable apparatus. A rolling motion around one of the axes of symmetry of the portable apparatus is preferred. In the case of a cubical apparatus these would be, for example, the mutually perpendicular axes through the center of symmetry of the cube. It is thus conceivable, for example, for the groups available on a cube surface to be displayed on a circular scale, similar to clock, selection of the group occurring by the fact that a corresponding portion of the scale that is assigned to the desired group is brought into a specific position by a rotational or rolling motion of the portable apparatus. It is additionally conceivable for confirmation of the selection to occur by touching a surface, via a key, via a voice input, or via a motion.

In addition, in the system according to the present invention the apparatus and/or the unit can comprise an acoustic output. The use of haptic outputs known from the existing art is also conceivable, in order to further improve the intuitive interaction between the portable apparatus and a user. The use of a vibratory output may be recited merely by way of example.

Because the portable apparatus is intended to work at least temporarily without a connection to an energy grid, it is preferably embodied with an energy reservoir or with a receptacle for an energy reservoir, and optionally with an energy reserve indicator. Particularly preferably, the portable apparatus possesses an inductive charging function. It is thus possible, for example, for the portable apparatus to possess an inductive charging function which allows it to be placed in a charging cradle in order to charge the energy reservoir. Particularly preferably, provision is made that the inductive charging function is embodied for non-contact charging of the energy reservoir. According to a particular embodiment, provision can be made for this purpose that the charging cradle and/or the portable apparatus possesses magnetic means that enable the portable apparatus to be held in a floating state above the charging cradle while the energy reservoir is charged with the aid of the inductive charging function. Provision is usefully, but not obligatorily, made that the charging cradle possesses a communication unit that can enter into contact with the communication unit of the portable apparatus for data exchange. The charging cradle can thus also encompass the function of a docking station having the aforementioned functional scope.

Provision is further made, in an embodiment, that the evaluation and control unit and the communication unit are additionally designed for the exchange and storage of person-specific data.

In order to enable interaction of the system according to the present invention, in particular of the portable apparatus, with a docking station, for example of the aforementioned stationary unit in the form of a receptacle for the portable apparatus, provision can be made that the apparatus comprises at least one interface for data transfer and energy transfer with a docking station.

The method according to the present invention for wireless location-independent operation, control, and configuration of electronic building-automation devices and components, using a system according to one of the preceding claims, comprises the steps of:

a) identifying at least one stationary unit;

b) creating a wireless communication connection between a portable or handheld apparatus and at least one of the identified stationary units;

c) carrying out a state query in the context of at least one of the identified units, and transferring the query result to the apparatus; and

d) outputting at least one state query result of at least one of the localized units via an information output unit of the apparatus.

Particularly preferably, the identification occurs on the basis of an approach by the apparatus, ascertained by a proximity sensor, to at least one stationary unit.

The method according to the present invention can furthermore additionally comprise the step of:

e) transmitting to a unit, in remotely communicative fashion, a state signal that contains information regarding a desired state of the corresponding unit.

If provision is made that the portable unit is in remotely communicative connection with a docking station, the creation of a wireless communication connection is then to encompass the creation of a connection to a docking station.

Lastly, the method according to the present invention can further comprise the steps of:

a1) activating the communication unit of the apparatus via the proximity sensor when the distance between apparatus and unit falls below a minimum value; and

e1) deactivating the communication unit via the proximity sensor when the maximum distance is exceeded.

Activation of the communication unit is preferably to follow the identification of at least one stationary unit, and deactivation of the communication unit is preferably to follow all the method steps for which an existing wireless communication connection between the apparatus and at least one of the identified units must exist.

Depending on the embodiment of the invention, at least one functionality is activated or deactivated as a function of the location and/or the whereabouts of the apparatus.

Particularly preferably, identification and/or transfer occurs with the aid of RF technology.

An example of the functional scope of a system according to the present invention will be presented below using the example of a cubical portable apparatus. The cubical geometry of the portable apparatus was selected for the presentation that follows in particular because it permits a particularly illustrative description of the invention. One skilled in the art will recognize that all the functions described below with reference to a cubical portable apparatus can readily, and in particular without inventive action, be transferred to a portable apparatus having a different geometry. An example that may be mentioned is that the geometric properties of a cube can be transferred onto those of a sphere, for example by assuming that the sphere contains a cube whose eight corners are exactly in contact with the spherical surface. The surfaces of the cube thus also correlate with corresponding surfaces (or surface segments) on the spherical surface, the cube faces being, in a way, projected onto the spherical surface. One skilled in the art will recognize that analogous considerations are possible for a multiplicity of portable apparatuses that deviate from cubical geometry.

In order to implement maximally intuitive operability of the system according to the present invention, provision is made for implementing substantial parts thereof on the basis of gestural control. On the technical side, this requires the means recited earlier on, which enable in particular the evaluation of rotational and translational motions of the portable apparatus in space or with reference to at least one stationary unit.

In the case of a cubical portable apparatus, this control is based preferably on an evaluation of the actual motion of the portable apparatus with reference to its three spatial axes. In addition to the three translational motions along the spatial axes, a rotational motion of the apparatus around the respective spatial axis can also be respectively utilized for gestural control.

If, for example, one or more operating functions are associated with a cube surface, selection of the surface, and thus selection of the operating functions, can then occur in the following manner:

a. touching the corresponding surface; and/or

b. actuating a mechanical button that is present on the corresponding surface; and/or

c. orienting a surface in space with simultaneous evaluation of the earth's gravitational field; and/or

d. orienting the surface with reference to a stationary unit; and/or

e. rotating the cube around a spatial axis.

It is furthermore useful, for situation-dependent information configuration, that the functional scope of the portable apparatus is based on its whereabouts, i.e. its surroundings. It is thus conceivable, for example, for the apparatus to detect, within a building, the room in which it is located, the floor on which it is located, or whether it is located outside the building. It is moreover conceivable for the detection of the whereabouts to occur by detection of specific device constellations or device IDs.

Because the scope of possible operating actions of the system according to the present invention is fundamentally not intended to be limited to specific interactions, the following may be recited merely by way of example: select, deselect, confirm, delete, increase/decrease a value, fast forward (FWD/REW), next (forward/backward), adjust the volume of an acoustic output, switch between two functions, screw down/unscrew, switch on/off, home/exit, reset, abort, search, sniff/listen, zoom +/−.

Intuitive actuation of an operating function via the portable apparatus is to occur essentially via motions, buttons, and acoustic inputs. Examples of embodiments of the sensors that are suitable for detecting the aforesaid operating actions have already been recited above. Actuation of an operating function can thus be carried out in the following manner:

a. PAN, TILT, ROLL (horizontal, vertical, rolling rotation)

b. LEFT, RIGHT, UP, DOWN (+/− X, Y motion)

c. NEARBY, AWAY (+/− Z motion, movement toward/away from a stationary unit)

d. DELETE (shake the portable apparatus)

e. TAKE (single motion in Z direction)

f. UNTAKE (single motion in X direction)

g. VOICE (sounds or voice)

h. TOUCH (touch a touch-sensitive surface)

i. PUSHBUTTON (push a button or surface)

j. TURN (actuate touchwheel)

k. SCROLL (actuate slide controller)

l. SQUEEZE (squeeze the portable apparatus)

m. RUB (rub on a surface).

Interaction with the portable apparatus occurs principally via its (six) surfaces and the respectively associated surface functions. The following may be mentioned merely by way of example:

| Surface | | |
|---|---|---|
| functions | Sub-functions | Clients |
| Configure | Link | Unit - Unit |
| | Group | Unit - Group |
| | Cancel | Group - Group |
| Read out and | Sensor data of a stationary unit | Power consumption |
| display | | Temperature |
| | | Mailbox |
| | | Air quality |
| | | Gas consumption |
| | | Climate data |
| | | Windows/doors |
| | State of a stationary unit | Active |
| | | Passive |
| | | Alarm |
| | | Malfunction |
| | Property of a stationary unit | Type of unit |
| | | Group membership |
| Control | Actuate an actuator of a | Light |
| | stationary unit | Blinds |
| | | Climate |
| | | Electrical outlets |
| | Security | Door intercoms |
| | | Alarm systems |
| | | Hazard sensors (fire, |
| | | smoke, water) |
| | Media | Music |
| | | Photos |
| | | Films |
| Program | Timer | e.g. switching function of |
| | | an outlet |
| | Parameterize | e.g. switching thresholds |
| | Regulate | e.g. heating/ventilation |
| | Control | e.g. lighting |
| | Delete | e.g. a timer function |
| | Reset | e.g. a component |
| Save | States of units | |
| | System states | |
| | Sensor data | |
| | Personal data | |
| Transmit | Receive | Portable apparatus as |
| | Transfer | data relay |
| | Forward | |

An interaction scheme using the example of the “Link” function is presented schematically below. The example describes the process of “linking,” in order to associate the switch function of a light switch with a lamp. The linking process between the portable apparatus and the switch precedes the linking of the apparatus to the lamp. Be it noted that this sequence can also be reversed.

Variant 1: Linking a Light Switch to a Lamp By Means of a Transaction (Automatic Grouping)

1. User action: bring portable apparatus into near field of switch
automatically: communication is established
automatically: switch is detected
automatically: portable apparatus goes into “Switch” mode, i.e. the surfaces of the portable apparatus acquire functions from the switch context.

2. User action: select “Link” function

3. User action: confirm “Link” function
automatically: switch is assigned to a group
automatically:
   i. Alternative 1: visible output: “Assign object now” (e.g. text or light signal)
   ii. Alternative 2: acoustic output: “Show me what I need to switch.”

4. User action: bring portable apparatus into near field of lamp
automatically: communication is established
automatically: lamp is detected
automatically: portable apparatus goes into “Lamp” mode, i.e. the surfaces of the portable apparatus acquire functions from the lamp context
automatically: select “Link” function
automatically:
   i. Alternative 1: visible output: “Select object?” (e.g. text or light signal)
   ii. Alternative 2: acoustic output: “Select lamp?”

5. User action: confirm (e.g. button or “Yes” voice input).

Variant 2: Linking a Light Switch to a Lamp by Grouping (Manual Grouping)

1. User action: bring portable apparatus into near field of switch
automatically: communication is established
automatically: switch is detected
automatically: portable apparatus goes into “Switch” mode, i.e. the surfaces of the portable apparatus acquire functions from the switch context.

2. User action: select “Grouping” function
automatically: Grouping capabilities are displayed

3. User action: allocate to a group
automatically:
   i. Alternative 1: visible output: “Device has been assigned”(e.g. text or light signal)
   ii. Alternative 2: acoustic output: “Device has been assigned.”

Examples of interaction diagrams for interaction between a portable apparatus and a heating thermostat, an electrical outlet, a mailbox, and a switch are indicated below.

### Example 1

### Heating Thermostat

| | Sub- | | | | Action of |
|---|---|---|---|---|---|
| Surface function | functions | Parameter | Heating thermostat | | portable apparatus |
| Configure | Link | Group | similar to Variant 2 | | NEARBY |
| | | | (see above) | | PAN |
| | | | | | ROLL until pointer is |
| | | | | | on group, then |
| | | | | | TAKE or |
| | | | | | PUSHBUTTON |
| Read out and display | Sensor | Temper- | 1. | User action: bring | NEARBY |
| | data | ature | | portable apparatus | |
| | | | | into near field of | |
| | | | | thermostat | |
| | | | | automatically: | |
| | | | | communication is | |
| | | | | established | |
| | | | | automatically: | |
| | | | | thermostat is | |
| | | | | detected | |
| | | | | automatically: | |
| | | | | portable | |
| | | | | apparatus goes | |
| | | | | into “Thermostat” | |
| | | | | mode | |
| | | | | automatically: | |
| | | | | read out and | |
| | | | | display | |
| | | | | temperature | |
| | State | Active | 1. | Begin as above | PAN then SCROLL |
| | | Passive | 2. | User action: | for individual status |
| | | Alarm | | select “State” | messages |
| | | Mal- | | function | |
| | | function | | automatically: | |
| | | | | read out and | |
| | | | | display a state | |
| | Properties | Type of unit | 1. | Begin as above | PAN then SCROLL |
| | | Grouping | 2. | User action: | for individual status |
| | | | | select “State” | messages |
| | | | | function | |
| | | | | automatically: | |
| | | | | read out and | |
| | | | | display properties | |
| Control | Actuators | Setpoint | 1. | Begin as above | PAN |
| | | temper- | 2. | User action: | PUSHBUTTON |
| | | ature | | select “Set | and ROLL |
| | | | | temperature” | |
| | | | | function | |
| | | | 3. | User action: set | |
| | | | | new setpoint | |
| | | | | temperature | |
| Program | Timer | Switching | 1. | Begin as above | PAN |
| | parameters | times | 2. | User action: | |
| | | Setpoint | | select “Set | PUSHBUTTON |
| | | temper- | | temperature” | and ROLL |
| | | ature | | function | |
| | | | 3. | User action: set | |
| | | | | new setpoint | |
| | | | | temperature | |
| Save | State | Temperature | 1. | Begin as above | |
| | | curve | 2. | User action: | PAN |
| | | | | select “Save | PUSHBUTTON |
| | | | | temperature curve” | |
| | | | | function | |
| | | | 3. | User action: save | |
| | | | | temperature curve | |
| Transmit | Transfer | Data | 1. | Begin as above | PAN |
| | | | 2. | User action: | TAKE |
| | | | | select “Synchronize | |
| | | | | with PC” function | |
| | | | 3. | User action: | |
| | | | | confirm | |

### Example 2

### Electrical Outlet

| | Sub- | | | | Action of portable |
|---|---|---|---|---|---|
| Surface function | functions | Parameter | Heating thermostat | | apparatus |
| Configure | Link | Group | similar to Variant 2 | | NEARBY |
| | | | (see above) | | PAN |
| | | | | | ROLL until pointer is |
| | | | | | on group, then TAKE |
| | | | | | or PUSHBUTTON |
| Read out and display | Sensor | Power | 1. | User action: bring | NEARBY |
| | data | consumption | | portable | |
| | | | | apparatus into | |
| | | | | near field of outlet | |
| | | | | automatically: | |
| | | | | communication is | |
| | | | | established | |
| | | | | automatically: | |
| | | | | outlet is detected | |
| | | | | automatically: | |
| | | | | portable | |
| | | | | apparatus goes | |
| | | | | into “Outlet” | |
| | | | | mode | |
| | | | | automatically: | |
| | | | | read out and | |
| | | | | display | |
| | | | | temperature | |
| | Switch-on | Times | 1. | Begin as above | PAN then ROLL for |
| | times | | 2. | User action: select | individual displayed |
| | | | | “Switch-on times” | values |
| | | | | function | PUSH to select |
| | | | | automatically: | desired function |
| | | | | read out and | |
| | | | | display switch-on | |
| | | | | times | |
| | Properties | Type of unit | 1. | Begin as above | PAN then ROLL for |
| | | Grouping | 2. | User action: select | individual displayed |
| | | | | “Grouping” | values |
| | | | | function | PUSH to select |
| | | | | automatically: | desired function |
| | | | | read out and | |
| | | | | display grouping | |
| Control | Actuators | On/Off/Dim | 1. | Begin as above | PAN then ROLL for |
| | | | 2. | User action: select | individual control |
| | | | | “Control” | functions |
| | | | | function | PUSH to select |
| | | | 3. | Select function: | desired function |
| | | | 4. | On/off: shake or | ROLL to dim |
| | | | | PUSH | |
| | | | 5. | Dim: roll portable | |
| | | | | apparatus | |
| Program | Timer | Switch-on and | 1. | Begin as above | PAN then ROLL to |
| | parameters | switch-off | 2. | User action: select | select Switching |
| | | times | | “Program | times programming |
| | | | | switching times” | function. |
| | | | | function | ROLL and PUSH to |
| | | | 3. | Display a time | set time. |
| | | | | and roll/ | |
| | | | | push button to | |
| | | | | select a time | |
| | | | 4. | Roll to define ON | |
| | | | | or OFF at time | |
| | Alarm | Consumption | 1. | Begin as above | PAN then ROLL to |
| | function | value | 2. | User action: select | select Alarm |
| | | | | “Program | programming |
| | | | | consumption | function |
| | | | | value” function | ROLL and PUSH to |
| | | | 3. | User action: select | set monitoring time |
| | | | | time period: | period. |
| | | | | recent, day, week, | ROLL and PUSH for |
| | | | | month. | setting the alarm |
| | | | 4. | Display a scale of | value. |
| | | | | values and | |
| | | | | roll/push button | |
| | | | | to select an | |
| | | | | alarm value. | |
| Transmit | Transfer | | 1. | Begin as above | PAN |
| | | | 2. | User action: select | TAKE |
| | | | | “Synchronize with | |
| | | | | PC” function | |
| | | | | (consumption | |
| | | | | values, | |
| | | | | programming) | |
| | | | 3. | User action: | |
| | | | | confirm | |

### Example 3

### Mailbox

| | Sub- | | | | Action of portable |
|---|---|---|---|---|---|
| Surface function | functions | Parameter | Mailbox sensor | | apparatus |
| Configure | Link | Group | 1. | User action: bring | NEARBY |
| | | | | portable apparatus | PAN |
| | | | | into near field of | ROLL until pointer is |
| | | | | mailbox | on group, then |
| | | | | automatically: | TAKE or |
| | | | | communication is | PUSHBUTTON |
| | | | | established | |
| | | | | automatically: | |
| | | | | mailbox is | |
| | | | | detected | |
| | | | | automatically: | |
| | | | | portable apparatus | |
| | | | | goes into “Mailbox | |
| | | | | sensor” mode | |
| Read out and display | Sensor | Event of | | automatically: | NEARBY |
| | data | corresponding | | read out and | |
| | | group | | display last event | |
| | State | Active | 1. | Begin as above | PAN then SCROLL |
| | | Passive | 2. | User action: select | for individual status |
| | | Alarm | | “State” function | messages |
| | | Malfunction | | automatically: read | |
| | | | | out and display | |
| | | | | state | |
| | Properties | Type of unit | 1. | Begin as above | PAN then SCROLL |
| | | Grouping | 2. | User action: select | for individual status |
| | | | | “State” function | messages |
| | | | | automatically: read | |
| | | | | out and display | |
| | | | | properties | |
| Program | Parameters | Setpoint for | 1. | Begin as above | PAN |
| | Reset | alarm | 2. | User action: select | PUSHBUTTON and |
| | | Reset type | | “Set setpoint” | ROLL |
| | | Reset time | | function | Shake |
| | | | 3. | User action: set | |
| | | | | new setpoint | |
| | | | 4. | User action: reset | |
| | | | | setpoint | |
| Transmit | Transfer | | 1. | Begin as above | PAN |
| | | | 2. | User action: select | TAKE |
| | | | | “Synchronize with | |
| | | | | PC” function | |
| | | | | (programming) | |
| | | | 3. | User action: | |
| | | | | confirm | |

Advantageous embodiments of the invention are explained with reference to the Figures that follow, in which:

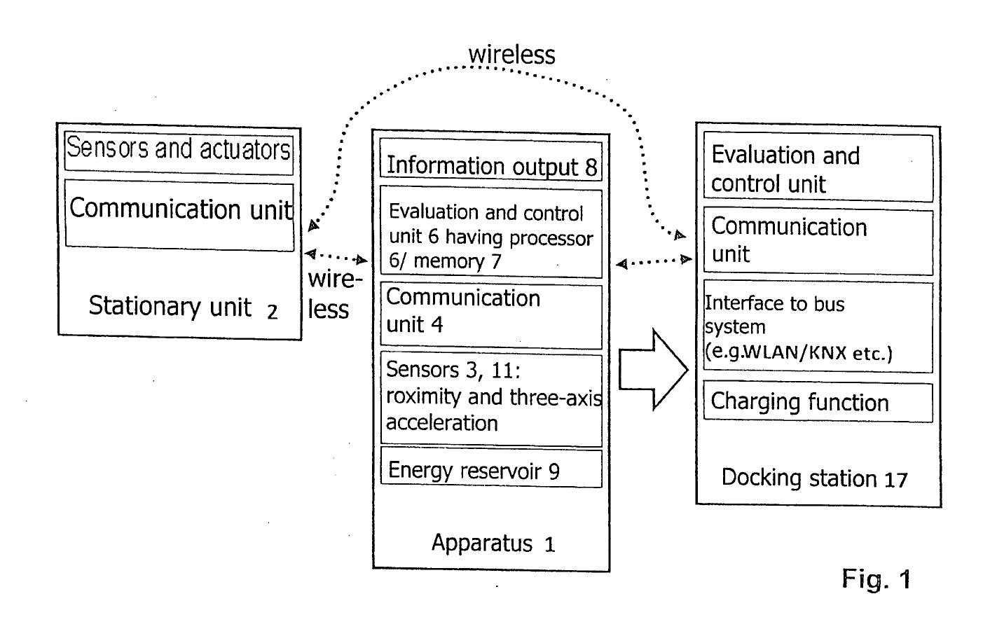

FIG. 1 shows a diagram of communication between a portable apparatus and a stationary unit as well as a docking station;

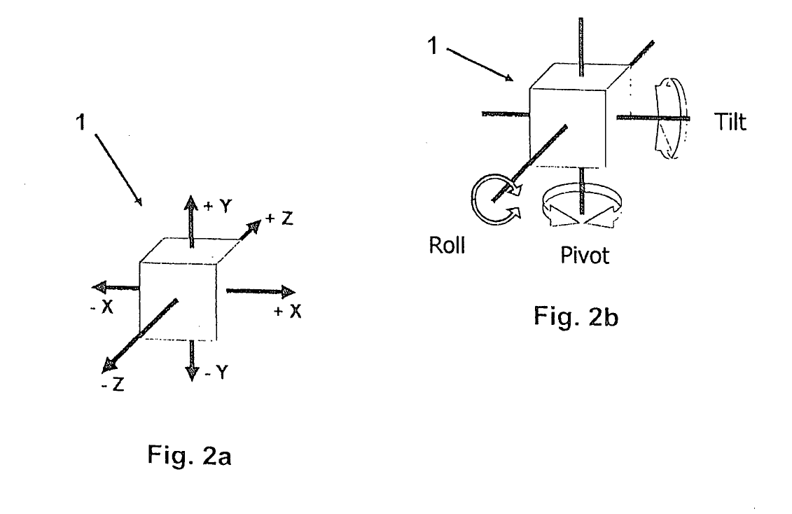

FIGS. 2a and 2b show possible interactions between a user and a substantially cubical portable apparatus, based on translational and rotational motions;

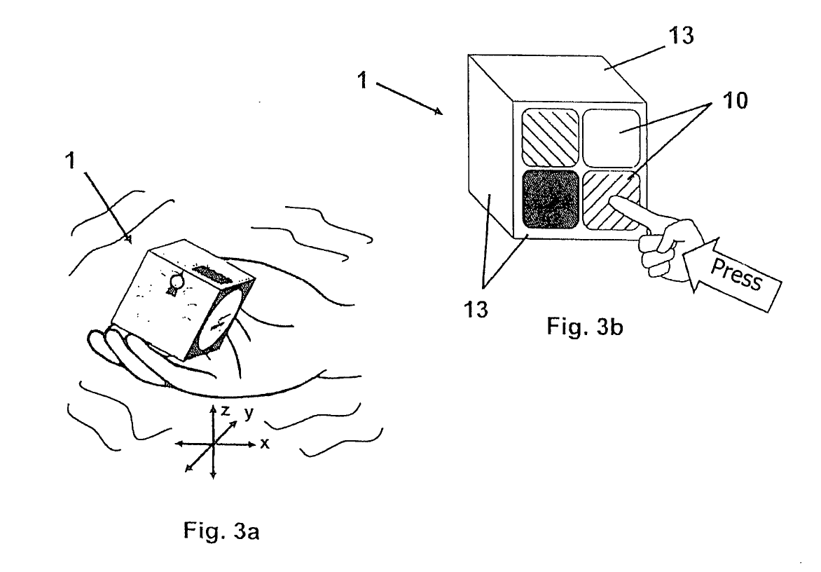

FIGS. 3a and 3b show possible interactions between a user and a substantially cubical portable apparatus, based on a shaking motion or a touch contact;

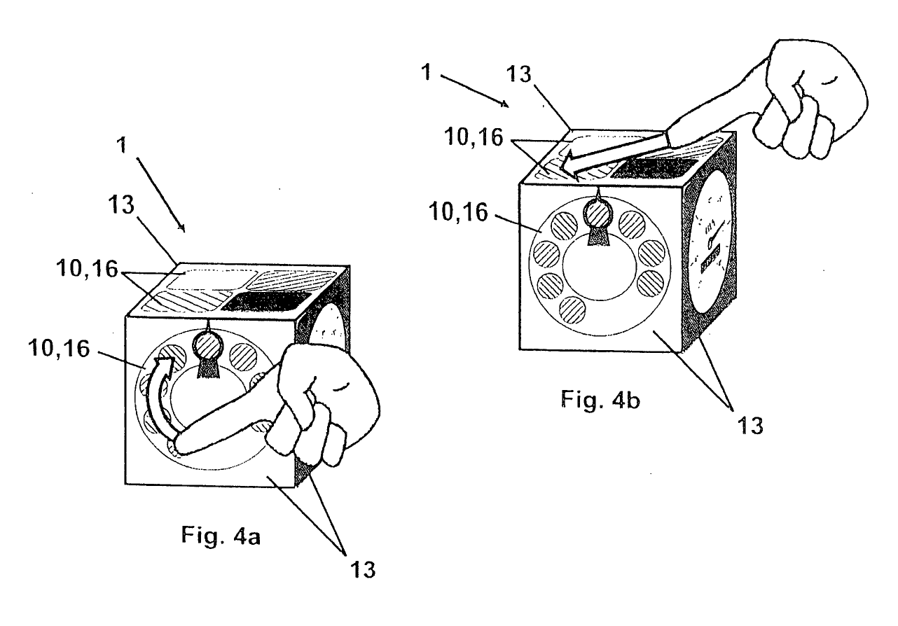

FIGS. 4a and 4b show possible interactions between a user and a substantially cubical portable apparatus, based on moving touch contacts;

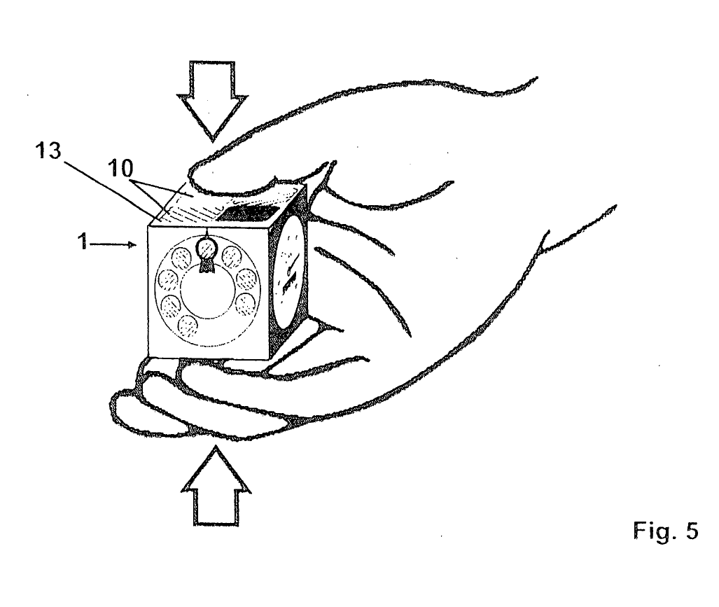

FIG. 5 shows possible interactions between a user and a substantially cubical portable apparatus, based on application of a force;

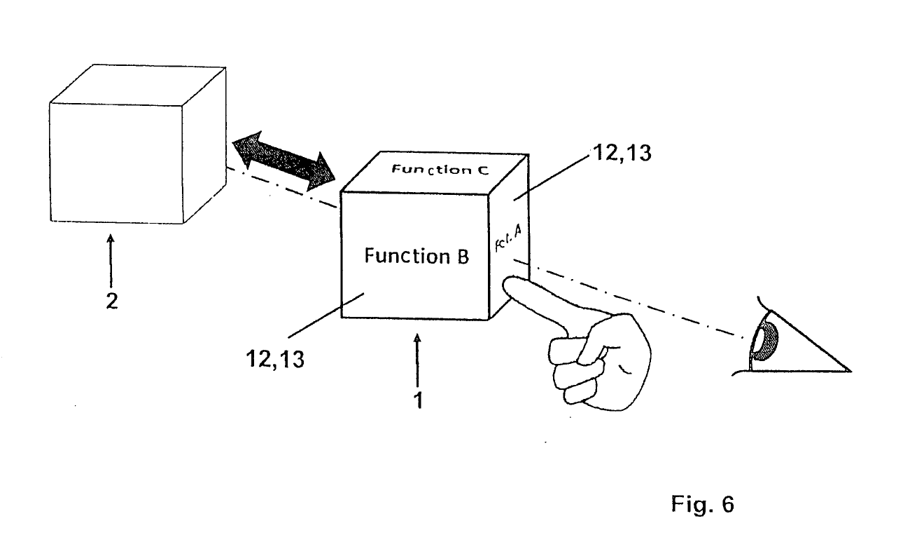

FIG. 6 schematically depicts the selection of a surface function of the portable apparatus with reference to a stationary unit;

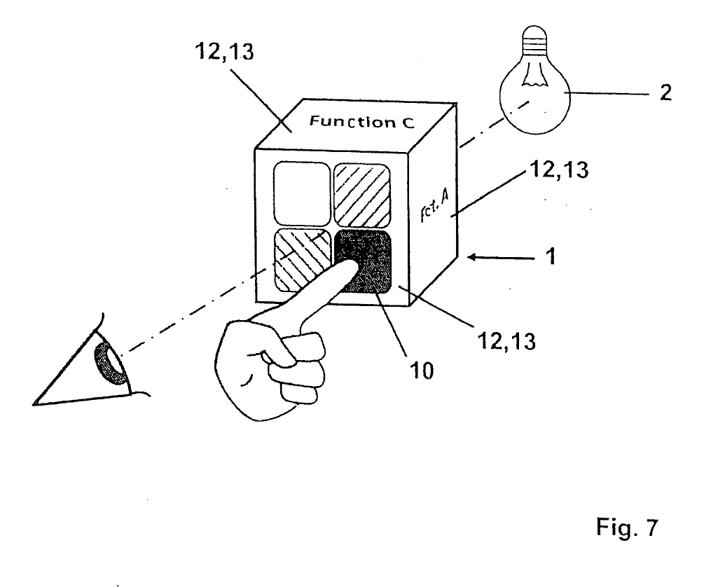

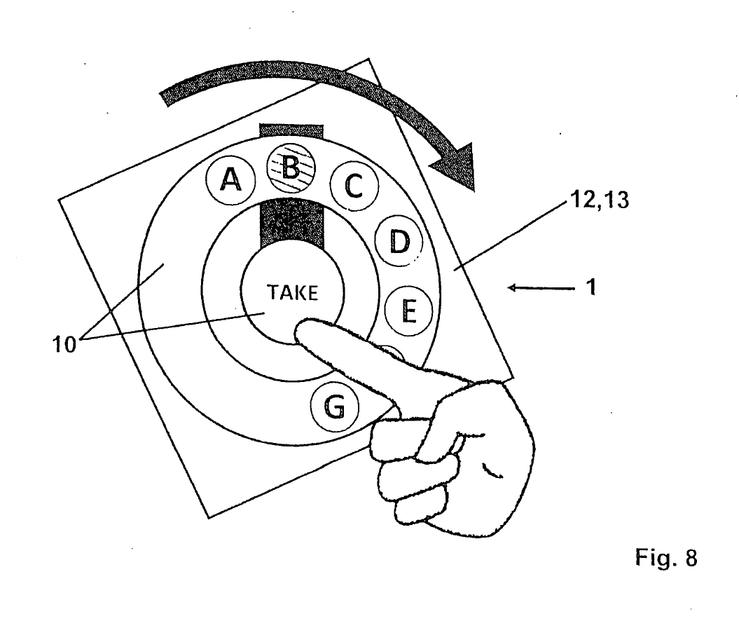

FIG. 7 schematically depicts the assignment of a stationary unit to a group of stationary units;

FIG. 8 schematically depicts the selection of a surface function by way of a display having an input element;

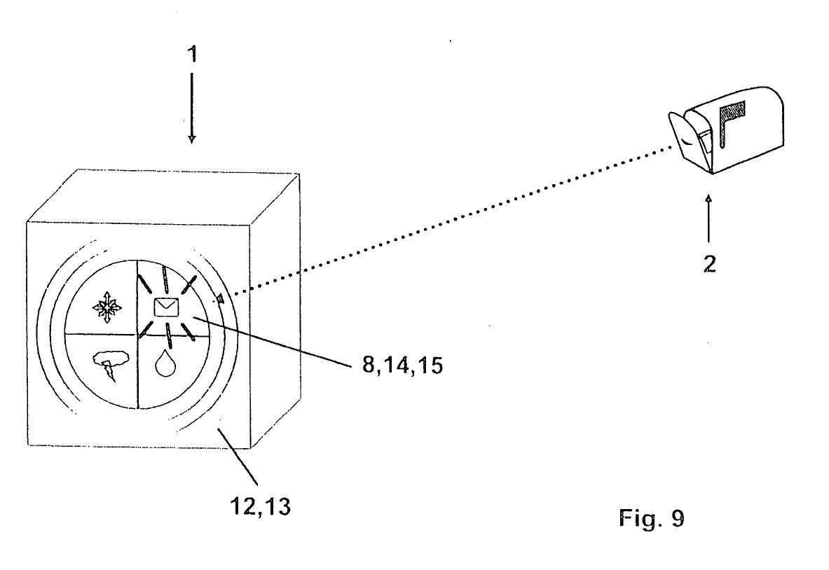

FIG. 9 schematically depicts the visual display of the state of a stationary unit;

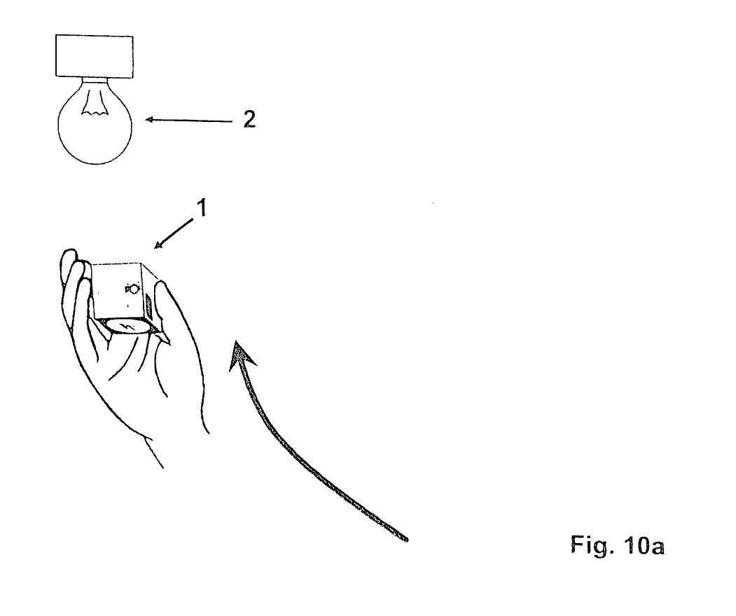

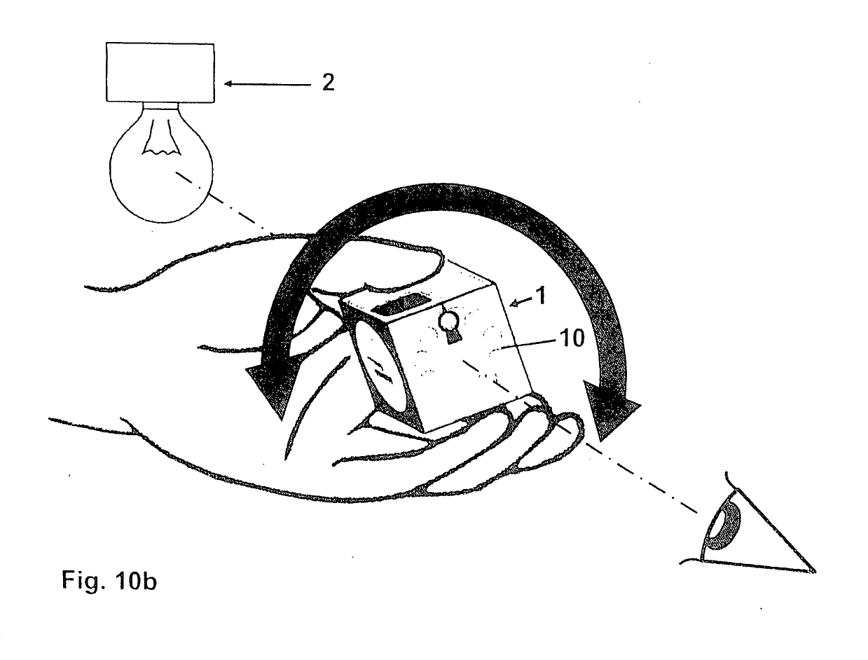

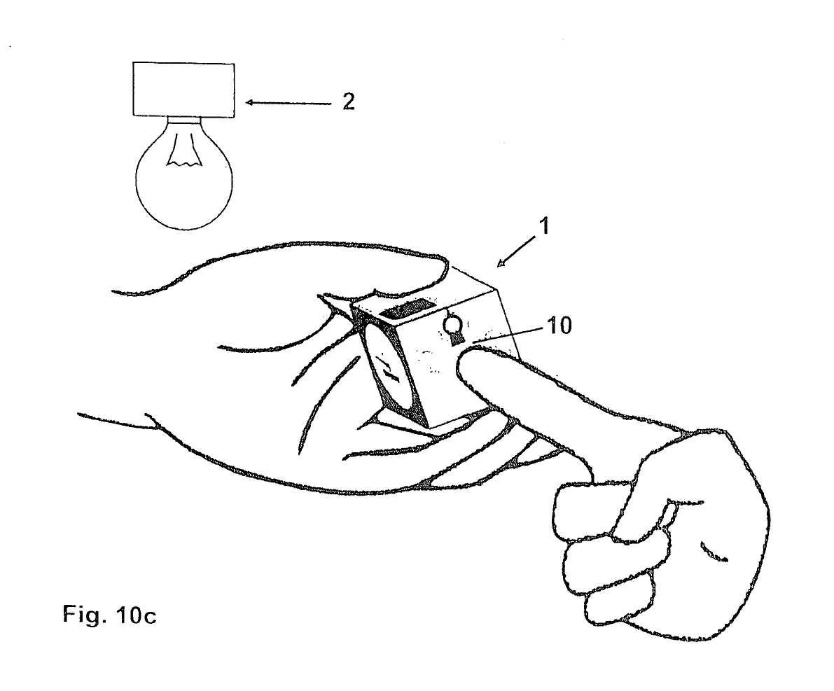

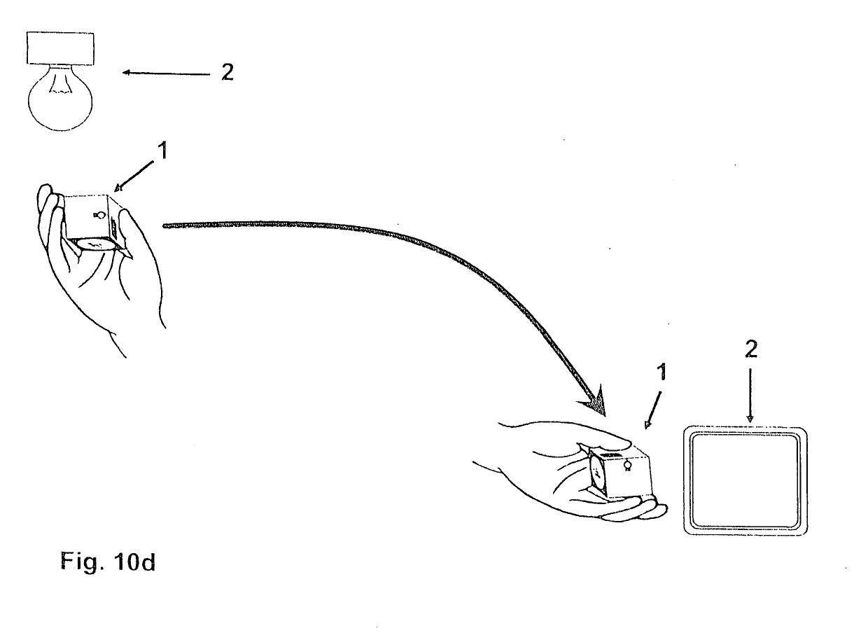

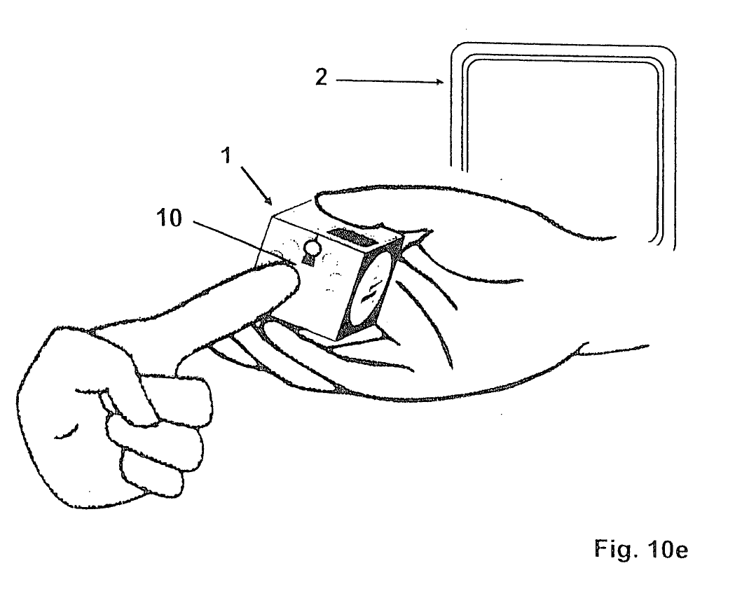

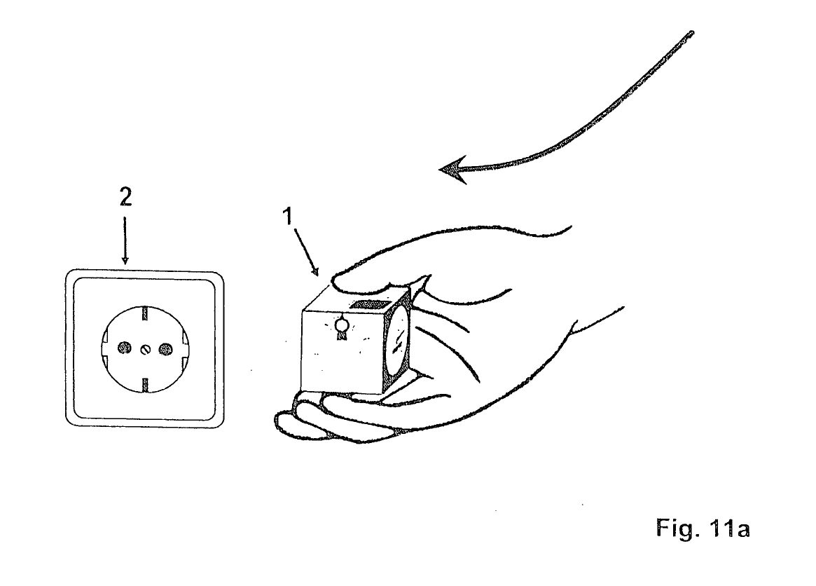

FIGS. 10a to 10c schematically depict the linking of a light switch to a lamp by means of a transaction;

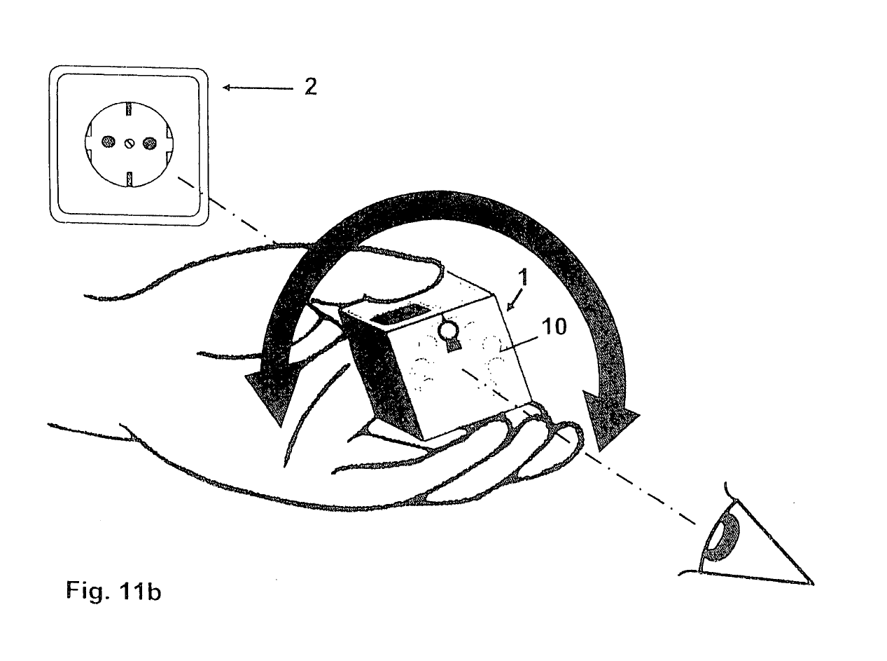

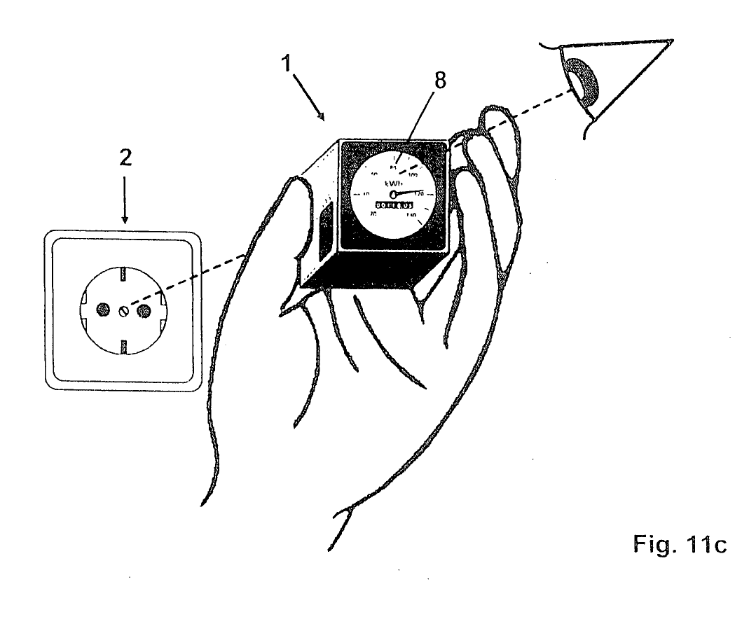

FIGS. 11a to 11c schematically depict the determination of energy consumption at an electrical outlet as a consequence of a transaction;

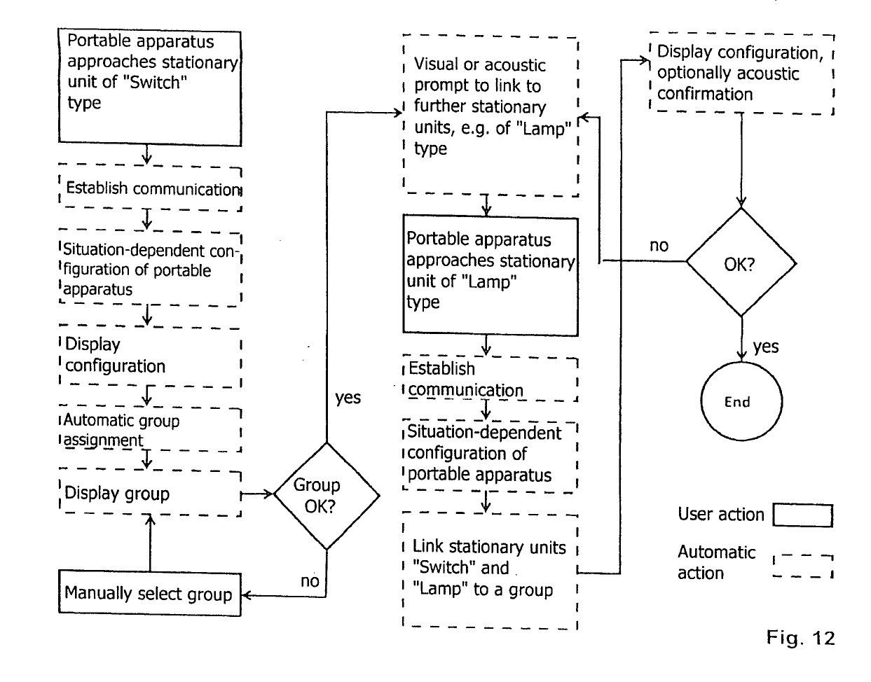

FIG. 12 is a flow chart for a transaction according to FIGS. 10a to 10e; and

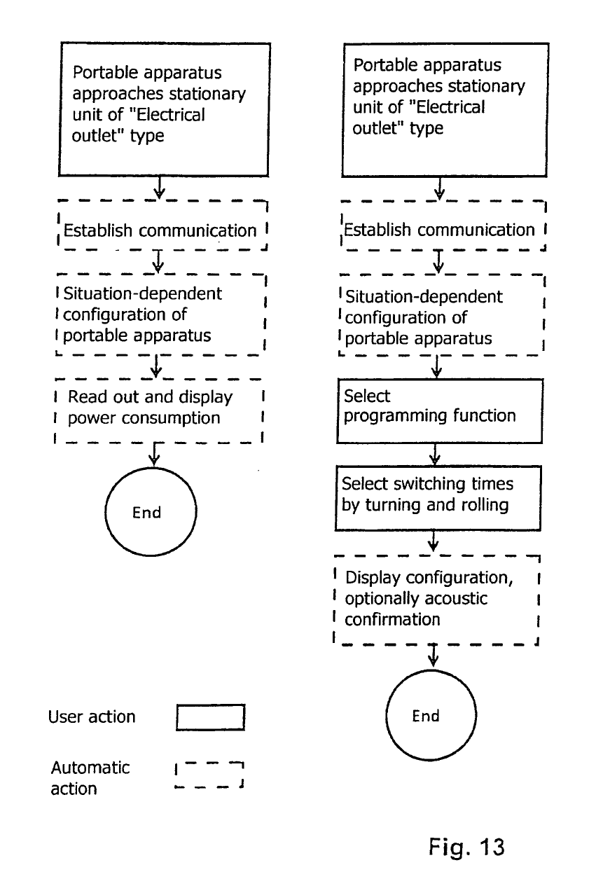

FIG. 13 is a flow chart for a transaction according to FIGS. 11a to 11c. FIG. 1 illustrates the possible communication configuration between a portable apparatus 1 and a stationary unit 2 and a docking station 17. As provided according to the present invention, portable apparatus 1 comprises a communication unit 4, an evaluation and control unit 5 having a processor 6 and a memory 7, an information output unit 8, a proximity sensor 3, and an energy reservoir 9. In addition, the exemplifying apparatus 1 according to FIG. 1 is intended to encompass a three-axis acceleration sensor. Stationary unit 2 also comprises, besides sensors and/or actuators, a communication unit with which it can enter wirelessly into communication at least with portable apparatus 1, for example as a consequence of an approach, ascertained by proximity sensor 3 of portable apparatus 1, of apparatus 1 to stationary unit 2. Docking station 17 can be provided in particular to make available a storage location for portable apparatus 1. It is furthermore useful to embody docking station 17 in such a way that it also serves to recharge energy reservoir 9, and for that purpose has a charging function. Lastly, docking station 17 can also serve as an interface to a centralized home control bus system, for which it comprises a suitable data-transfer, and if necessary energy-transfer, connection to the home control bus system. Provision is made that docking station 17 likewise possesses a communication unit with which it can enter into wireless communication with portable apparatus 1 for data exchange. Depending on the embodiment, it may also be useful for docking station 17 likewise to be wirelessly connected to stationary unit 2 for data exchange, so as thereby to create, for example, a communication connection between the home control bus system (connected via docking station 17) and stationary unit 2. As indicated by the arrow, provision can be made that control instructions proceeding from apparatus 1 are always communicated to docking station 17 regardless of whether they are provided for the application of control to stationary unit 2. This makes it possible for the control instructions sent out from apparatus 1 in order to control stationary unit 1 to experience a calibration by docking station 17, or by a home control bus system connected thereto, before being forwarded to stationary unit 2. The control instruction communication procedure recited above can be useful for avoiding system conflicts, for example in the case in which multiple portable apparatuses 1 are sending contradictory control instructions to a stationary unit 2.

FIGS. 2a and 2b show possible motion variants for the intuitive interaction of a user with portable apparatus 1. It is useful for this purpose for portable apparatus 1 to possess corresponding motion- and/or acceleration-sensitive sensors, and an evaluation unit directed to the evaluation thereof. The substantially cubical apparatus 1 depicted in FIGS. 2a and 2b offers, for interaction of a user with apparatus 1, the evaluation of a motion of apparatus 1 in particular in terms of the three axes of symmetry of the cube. These can be, in particular, translational motions along the axes of symmetry drawn in FIG. 2a, but also rotational motions around those same axes, as depicted in FIG. 2b.

Further motion variants that can be evaluated for interaction between a user and the cubical apparatus 1 are depicted in FIGS. 3a and 3b. It has been found that a shaking motion, depicted in FIG. 3a, is perceived as a particularly intuitive interaction with apparatus 1 when the intention is to reset it to an initial state, to delete an input, to activate the apparatus from a resting state, or the like.

FIG. 3b depicts a portable apparatus 1 in which four input units 10 are provided on one of the surfaces 13. It may be that all input units 10 are implemented with the aid of a single touch-sensitive display. A user's interaction with apparatus 1 can thus occur in such a way that he or she touches one of input units 10 or, if it is a button, pushes it. As is likewise evident, the four input units 10 can have an at least partly different visible or haptic conformation. If at least two similar input units 10 are provided, they can, for example, be used in a particularly intuitive manner to combine two stationary units into one shared group, for example the “shaded group” according to FIG. 3b.

FIGS. 4a and 4b show further touch-based interaction layouts. According to FIG. 4a, for example, it is conceivable for portable apparatus 1 to encompass on one of its surfaces 13 a touch-sensitive display that permits an interaction with portable apparatus 1 via a circular sliding motion of, for example, a user's finger over the touch-sensitive surface 13. It is thus conceivable according to FIG. 4a, for example, for surface 13 to encompass an input unit 10 in which a selection of different input instructions is arranged along a circular path, from which instructions the user can select via a circular sliding motion over surface 13 along the circular path.

It is likewise possible according to FIG. 4b for a straight-line sliding motion over a touch-sensitive surface 13 to serve for a user's interaction with apparatus 1. Provision can be made for this purpose that multiple input units 10 are provided on the respective surface 13, so that the control instruction intended by a user can be derived from the motion of, for example, his or her finger over surface 13. For particularly intuitive interaction with apparatus 1 in order to group two stationary units, it is also possible in this fashion to implement a particular intuitive “pull and drop.” Input units 10 according to FIGS. 4a and 4b can thus, in particular, also encompass a touch-sensitive input 16.

In the embodiment according to FIG. 5, provision is made that for a user's interaction with apparatus 1, an evaluation of the force exerted on apparatus 1 is utilized. This evaluation preferably occurs in such a way that the force exerted on two sides of the cube located in parallel fashion opposite one another is ascertained. Particularly preferably, input units 10 reacting to pressure, which are located on opposite surfaces 13, are employed in this context. Usefully, at least one pressure-sensitive input unit 10 is located on each of the two surfaces.

FIG. 6 illustrates the selection of a surface function of portable apparatus 1 with reference to a stationary unit 2. As indicated by the double arrow, provision can be made here that portable apparatus 1 ascertains, with the aid of its proximity sensor, an approach to a portable apparatus 1, and thereupon initiates situation-related information configuration with reference to the ascertained stationary unit 2. This can encompass, for example, the assignment to surfaces 13 of portable apparatus 1 of functionalities 12 that are coordinated with communication with or control of stationary unit 2. A user now has the capability of selecting from the allocated functionalities 12 and, on the basis thereof, interacting with stationary unit 2. Provision can thus be made, for example, that activation of a specific functionality 12 occurs by the fact that surface 13 allocated to the corresponding functionality 12 assumes a specific arrangement with reference either to stationary unit 2 or to the user (indicated by the eye in FIG. 6). It is thus useful that in the case of a cubical portable apparatus 1, it is always a functionality 12 located on a surface 13 visible to the user that is activated. In the depiction, this would be either function A which is located on surface 13 facing toward the user, or function C, on the assumption that the user usually holds apparatus 1 at chest height.

FIG. 7 schematically depicts the assignment of a stationary unit 2 to a group of stationary units. As already indicated with reference to FIG. 3b, it may be useful to implement grouping with the aid of intuitively comprehensible visible or haptic means. For example, once the situation-related information configuration described with reference to FIG. 6 has taken place, for example as a consequence of an approach by portable apparatus 1 to stationary unit 2, a user can select, as shown in FIG. 7, the “Grouping” functionality by bringing into his or her field of view the surface 13 assigned to that functionality. Once the “Grouping” functionality has been selected, he or she now has the capability of assigning stationary unit 2 to a group. As depicted in FIG. 7, the user intends to assign stationary unit 2 to the “black” group by actuating an input element 10 having a correspondingly black background.

FIG. 8 schematically depicts the selection of a surface function via a display having an input element. The display need not obligatorily be touch-sensitive. Provision is made that functionalities arranged on a circular arc, and indicated in the depiction with capital letters A to G, are selected by rotating portable apparatus 1 in the plane occupied by surface 13, with the result that a constantly vertically oriented selection pointer indicates a preselection of one of the functionalities, depending on how apparatus 1 is oriented. One skilled in the art will recognize that in order to implement this embodiment, apparatus 1 should comprise a gravity sensor or the like. The functionality preselected by the vertical pointer as a function of the degree of rotation of apparatus 1 can be confirmed by the user, for example, by actuating a corresponding input element 10. As depicted in FIG. 8, this is the central TAKE button.

FIG. 9 schematically depicts the visible display of the state of a stationary unit 2, more precisely of a mailbox. FIG. 9 thus shows a simple embodiment of the invention in which portable apparatus 1 is designed solely to output a state information item regarding stationary unit 2. Provision is once again made that portable apparatus 1 comprises on one of surfaces 13 a functionality 12 configured in situation-dependent fashion, in the present case an information output unit 8 with which a state of mailbox 2 is displayable. In the present case this can encompass, for example, information as to whether there is mail in the mailbox. This could be implemented, for example, in such a way that mailbox 2 comprises a sensor which ascertains whether mailbox 2 has been opened, and if necessary when it was most recently opened. Information output unit 8 can be not only visually embodied, but can also, for example, encompass an acoustic output 14 or a haptic or tactile output 15.

FIGS. 10a to 10e are schematic depictions to illustrate the linking of a light switch to a lamp by means of a user transaction. In a first step depicted in FIG. 10a, the user action according to which portable apparatus 1 is brought into the near field of lamp 2 is executed. In a further step depicted in FIG. 10b, once situation-related information configuration has occurred the user can select the “Link” function. In the case depicted in FIG. 10b, this is intended to occur on the basis of the rotation, described with reference to FIG. 8, of apparatus 1, and via input element 10 described therein in further detail. Once the “Link” function has been selected by rotation of apparatus 1, confirmation (already described) of the “Link” function occurs by actuation of the central input element 10, as depicted in FIG. 10c.

In a further step depicted in FIG. 10d, the user conveys portable apparatus 1 out of the near field of the lamp into the near field of the switch. If portable apparatus 1 is, usefully, still in the “Link” mode, provision can be made that, once situation-related information configuration has occurred in the near field of the switch, apparatus 1 prompts the user to confirm the linking of the switch to the lamp, for example by actuating central input element 10 as depicted in FIG. 10e.

FIGS. 11a to 11c depict, as a further exemplifying embodiment of the invention, the determination of energy consumption at an electrical outlet as a consequence of a user transaction. In a first step as shown in FIG. 11a, portable apparatus 1 is once again brought into the near field of stationary unit 2, here into the near field of an electrical outlet. As a consequence of the approach, ascertained by the proximity sensor of portable apparatus 1, of portable apparatus 1 to stationary unit 2, situation-related information configuration is initialized. As already described with reference to FIGS. 8 and 10b, the user now has the capability of selecting a function (here the “Display consumption” function) via input unit 10. Once selection has occurred, a user can read out the power consumption via an information output unit 8. In the embodiment depicted according to FIG. 11c, provision is made that information output unit 8 is embodied on a surface of apparatus 1 that, for example, encompasses a display.

FIG. 12 shows a flow chart for a user transaction in accordance with FIGS. 10a to 10e. Besides the user actions already described with reference to FIGS. 10a to 10e, the flow chart also shows the automatically executing actions, interposed between the user actions, that were respectively initialized by a preceding user action.

FIG. 13 shows a flow chart for a user transaction in accordance with FIGS. 11a to 11c, once again depicting, in addition to the user actions, the automatically executing actions initialized by a respective user action.

The features of the invention that are disclosed in the description above, in the drawings, and in the claims can be essential to realization of the invention both individually and in any combination.

1-25. (canceled)

26. A system for building automation, made up of a portable or handheld apparatus for situation-related information configuration and of at least two stationary units, in which system the apparatus comprises a proximity sensor, a communication unit for wireless communication with at least one of the stationary units, an evaluation and control unit having at least one processor or logic unit and a memory, an information output unit, and an energy reservoir, the system being designed to create a wireless communication connection between the apparatus and at least one of the stationary units via the communication unit as a consequence of an approach by the apparatus, as ascertained by the proximity sensor, to at least one stationary unit, and to display a state of the at least one stationary unit via the information output unit, wherein the apparatus is able to detect a hierarchy between the at least two stationary units wherein the apparatus comprises at least one functionality whose manifestation depends on an existing hierarchy between the stationary units.

27. The system according to claim 26, wherein the apparatus comprises at least one functionality whose manifestation depends on the physical distance of the apparatus from at least one of the at least two stationary units.

28. The system according to claim 26, wherein the apparatus comprises at least one functionality whose manifestation depends on the spatial orientation or spatial location of the apparatus with reference to at least one of the at least two stationary units.

29. The system according to claim 26, wherein the apparatus comprises a functionality that depends on the orientation of the apparatus with reference to a definable coordinate system.

30. The system according to claim 26, wherein the apparatus comprises at least one surface to which a functionality is allocated, activation of the functionality occurring as a function of a spatial orientation or spatial location of the surface.

31. The system according to claim 26, wherein the apparatus is designed for the grouping of stationary units and for saving a grouping in the memory.

32. The system according to claim 26, wherein the apparatus is designed to transmit to a stationary unit, in remotely communicative fashion, a state signal that contains information about a desired state of that unit.

33. The system according to claim 32, wherein the apparatus comprises an input unit by way of which the desired state of a stationary unit or a desired state of the apparatus is definable.

34. The system according to claim 33, wherein the input unit comprises at least one motion sensor and/or acceleration sensor that is connected to the evaluation and control unit for data exchange, and that is designed to define, based on motions and/or accelerations of the apparatus, a desired state of a stationary unit or of the apparatus.

35. The system according to claim 33, wherein the apparatus comprises at least one position sensor and/or one biometric sensor for defining an operational state of the apparatus.

36. The system according to claim 26, wherein the apparatus is designed to define a hierarchy existing between the at least two stationary units.

37. The system according to claim 26, wherein the apparatus is designed to detect and/or define a hierarchy between the apparatus and further apparatuses for situation-related information configuration.

38. The system according to claim 26, wherein the apparatus and/or the stationary unit comprises an acoustic output, a haptic output, or a tactile output.

39. The system according to claim 26, wherein the apparatus comprises a touch-sensitive input or a tactile input.

40. The system according to claim 26, wherein the apparatus comprises an inductive charging function.

41. The system according to claim 26, wherein the evaluation and control unit and the communication unit are additionally designed for the exchange and storage of person-specific data.

42. The system according to claim 26, wherein the apparatus comprises at least one interface for data transfer and/or energy transfer with a docking station.

43. A method for wireless location-independent operation, control, and configuration of electronically controllable building-automation devices using a system according to claim 26, comprising the steps of:
a) identifying at least one stationary unit;
b) creating a wireless communication connection between a portable or handheld apparatus and at least one of the identified stationary units;
c) carrying out a state query in the context of at least one of the identified units, and transferring a query result to the apparatus; and
d) outputting at least one state query result via the information output unit of the apparatus, wherein the apparatus recognizes a hierarchy consisting between the at least two stationary units and the apparatus comprises at least one functionality whose manifestation depends on the existing hierarchy between the stationary units.

44. The method according to claim 43, in which the identification occurs on the basis of an approach by the apparatus, ascertained by the proximity sensor, to at least one of the at least two stationary units.

45. The method according to claim 43, that furthermore comprises the step of:
e) transmitting to a stationary unit, in remotely communicative fashion, a state signal that contains information regarding a desired state of the corresponding stationary unit.

46. The method according to claim 43, wherein the creation of a wireless communication connection encompasses the creation of a connection to a docking station.

47. The method according to claim 43, that furthermore comprises the steps of:
a1) activating the communication unit of the apparatus via the proximity sensor when the distance between the apparatus and a stationary unit falls below a minimum value; and
e1) deactivating the communication unit via the proximity sensor when a maximum distance is exceeded.

48. The method according to claim 43, in which at least one functionality is activated or deactivated as a function of the location and/or the whereabouts of the apparatus.

49. The method according to claim 43, in which identification and/or transfer occurs with the aid of RF technology.
